(19) United States
(12) Patent Application Publication
(10) Pub. No.: US 2007/0029152 A1
(43) Pub. Date: Feb. 8, 2007

(54) Four wheel drive system

(76) Inventor: Mark A. Joki, Dover, OH (US)

Correspondence Address: MICHAEL BEST & FRIEDRICH, LLP, 100 E WISCONSIN AVENUE, MILWAUKEE, WI, 53202, US

(21) Appl. No.: 10/578,173

(22) PCT Filed: Jan. 14, 2005
(86) PCT No.: PCT/US05/01288

§ 371 Date: May 4, 2006

Related U.S. Application Data
(60) Provisional application No. 60/537,247, filed on Jan. 14, 2004.

(51) Int. Cl. F16D 41/06

(52) U.S. Cl. 192/38

(57) ABSTRACT

A “torque-on-demand” (“TOD”) four wheel drive system comprising a slipper clutch or roller clutch positioned between a first rotatable component and a second rotatable component. The clutch comprises a first tubular component having a first axial slot and a second tubular component having a second axial slot. A control pin extends through and is axially moveable within the first and second slots. One of the first or second slots has a constant circumferntial width W and the other of the first and second slots has at least first and second portions along its axial length with the first and second portions having different circumferential widths. Axial movement of the control pin along the slots changes the clutch between 2WD and 4WD/TOD modes.

### BACKGROUND

A ‘torque-on-demand’ (TOD) four wheel drive system automatically applies torque to the front wheels when the rear wheels slip. An overrunning clutch can provide a low cost method for TOD. Such a system is explained in U.S. Pat. No. 6,602,159 and provides either TOD or full lock four wheel drive (4WD). In such a system, the front axle is always turning which adds parasitic drag to the vehicle, increasing fuel consumption. It is desirable to provide a mode that allows the front axle to be stopped, i.e. two wheel drive mode (2WD). Another undesirable feature of the current system using an overrunning clutch to provide TOD is that a drag brake must be used for clutch control which increases fuel consumption.

Referring to FIG. 1, a prior art four wheel drive control device 8 with TOD mode is shown. The control device 8 comprises a through shaft 1 delivering torque to the rear wheels, a sprocket 3 capable of driving the front wheels through a chain 2, an inner race 4 fitted over the shaft 1, a slipper 5 between the sprocket 3 and the inner race 4, and a brake 6 capable of causing drag torque on the slipper 5 by way of an actuator ring 6A which is keyed into the slipper 5. The inner race 4 has multiple axially oriented recesses 9 disposed around it's outer periphery and the slipper 5 has multiple recesses 10 disposed around it's inner periphery aligned with the recesses 9 in the inner race 4 to form pockets into which rollers 7 are placed. The slipper 5 is circumferentially discontinuous by virtue of an axial cut 11. The slipper 5 is generally loose in the bore of the sprocket 3. In conditions without wheel slip, the drive ratio to the front wheels is different to the rear such that the sprocket 3 rotates faster than the shaft 1. The friction of the slipper 5 in the sprocket 3 would tend to rotate the slipper 5 relative to the sprocket 3, but the friction of the drag brake 6 is greater than the slipper drag preventing such relative rotation. If the rear wheels slip, the sprocket 3 will tend to rotate slower than the shaft 1 because the vehicle speed reduces. The slipper drag is now in the same direction as the drag from the brake 6 causing the slipper 5 to rotate relative to the sprocket 3. Such relative rotation causes the rollers 7 to climb the sides of the recesses 9, 10 in the inner race 3 and the slipper 5. The slipper 5 expands in diameter as the rollers 7 climb in the recesses 9, 10 causing the slipper 5 to lock in the sprocket 3 and thereby transfer torque to the front wheels. Since the drag brake torque reverses in reverse rotation, the identical functions occur in reverse rotation. Removing the drag brake torque causes the slipper 5 to lock unconditionally. A substantial drag is required from the drag brake, which increases fuel consumption.

### SUMMARY

The present invention provides a “torque-on-demand” four wheel drive system comprising a slipper clutch or roller clutch positioned between a first rotatable component and a second rotatable component. The clutch comprises a first tubular component having a first axial slot and a second tubular component having a second axial slot. A control pin extends through and is axially moveable within the first and second slots. One of the first or second slots has a constant circumferential width W and the other of the first and second slots has at least first and second portions along its axial length with the first and second portions having different circumferential widths. Axial movement of the control pin along the slots changes the clutch between 2WD and 4WD/TOD modes.

### BRIEF DESCRIPTION OF THE DRAWINGS

FIG. 1 is a cross section through a plane perpendicular to the axis of the main shaft illustrating the principle of the bidirectional slipper clutch with drag brake providing TOD operation.

FIG. 2 is a cross section through a plane containing the axis of the main shaft of a slipper clutch assembly that is a first embodiment of the present invention.

FIG. 3 is a radially inward view along the line 3-3 in FIG. 2.

FIG. 4 is a schematic diagram of the mode select device for the slipper clutch assembly of FIG. 2.

FIG. 5 is a cross section through a plane containing the axis of the main shaft of a roller clutch assembly that is a second embodiment of the present invention.

FIG. 6 is a cross section through a plane containing the axis of the main shaft of a self contained slipper clutch that is a third embodiment of the present invention.

FIG. 7 is a cross section through a plane containing the axis of the main shaft of a self contained slipper clutch that is a fourth embodiment of the present invention.

FIG. 8 is a cross section through a plane containing the axis of the main shaft of a self contained slipper clutch that is a fifth embodiment of the present invention.

FIG. 9 is a radial view along the line to the main shaft showing the slot profiles of the device in FIG. 8.

### DETAILED DESCRIPTION OF THE PREFERRED EMBODIMENTS

The present invention will be described with reference to the accompanying drawing figures wherein like numbers represent like elements throughout. Certain terminology, for example, “lop”, “bottom”, “right”, “left”, “front”, “frontward”, “forward”, “back”, “rear” and “rearward”, is used in the following description for relative descriptive clarity only and is not intended to be limiting.

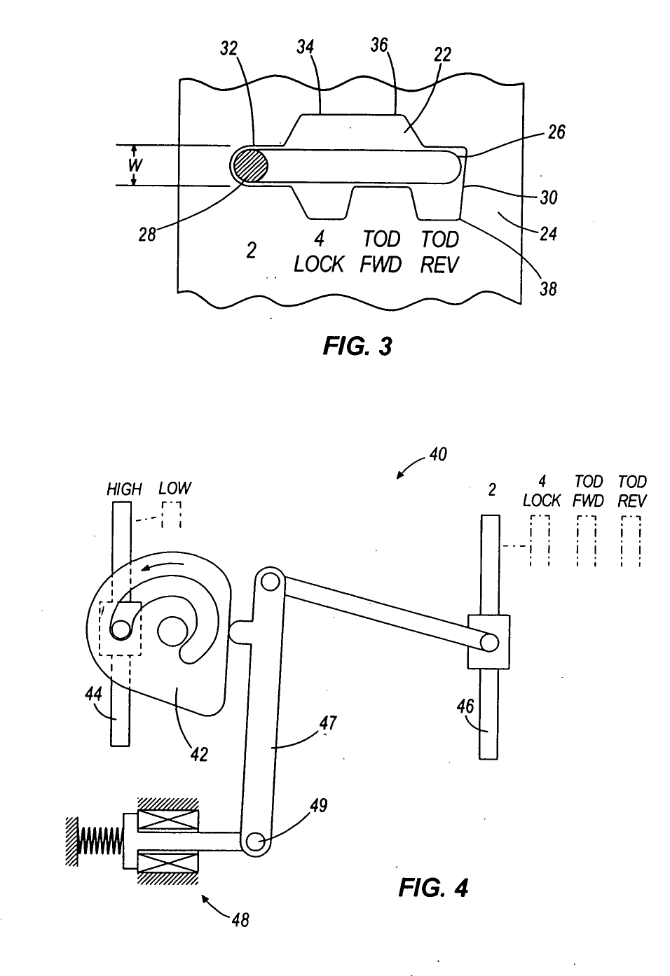

Referring to FIGS. 2 and 3, a slipper clutch assembly 20 that is a first embodiment of the present invention is shown. The slipper clutch assembly 20 generally includes an inner tube 22 rotationally fixed to the inner race 4 and outer tube 24 rotationally fixed to slipper 5. The inner tube 22 has an axial slot 26 and the outer tube 24 has an axial slot 30 overlying the inner tube axial slot 26. A pin 28 extends through both axial slots 26 and 30 and is moveable along the axis of the shaft 1 by an actuator plate 29. The inner tube axial slot 26 has a uniform width W. As illustrated in FIG. 3, the outer tube slot 30 has variable widths. Namely, the outer tube slot 30 has a first portion 32 that is substantially equal to the width W of the inner tube slot 26; a second portion 34 that is wider than the inner tube slot 26 in both circumferential directions; a third portion 36 that is wider than the inner tube slot 26 in one circumferential direction and a forth portion 38 that is wider than the inner tube slot 26 in the opposite circumferential direction.

When the pin 28 is located in the first portion 32 of the outer tube slot 30, the recesses 9, 10 of the inner race 4 and slipper 5 are aligned so that the rollers 7 cannot climb up the sides of the recesses 9, 10, preventing the slipper 5 from locking. This prevents torque from being transmitted to the front wheels, thereby providing a 2 wheel drive mode. The second portion 34 of the slot 30 allows relative rotation between the inner race 4 and the slipper 5 in both directions to provide fill freedom to unconditionally lock the slipper 5. When the pin 28 is in the third portion 36 of the slot 30, the system provides a forward TOD mode wherein locking is prevented when the sprocket 3 overruns the shaft 1 in forward and locks when the sprocket 3 is slower than the shaft 1. The fourth slot portion 38 provides a reverse TOD position in which the free and locking directions are reversed from that of the forward TOD mode. Various mechanisms may be utilized to provide the axial motion of the actuator plate 29 to select the desired operating mode.

Referring to FIG. 4, an illustrative mechanism 40 for axially moving the actuator plate 29 is shown. The mechanism 40 includes a gearmotor that turns a sector plate 42 to select the mode of the transfer case. A hi-low shift fork 44 is moved by the sector plate 42 as well as the slipper clutch control fork 46. The slipper clutch control fork 46 moves the actuator plate 29. A spring loaded solenoid 48 moves the pivot point 49 of a sector plate follower 47. When the transfer case is in TOD mode, it is in forward mode unless the solenoid 48 is actuated to move it to the TOD reverse mode.

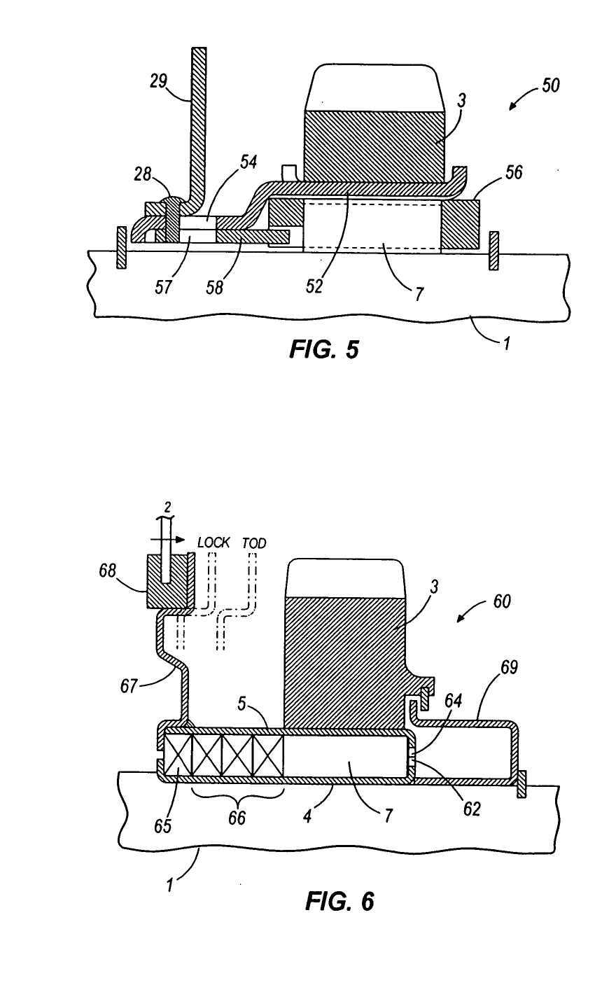

Referring to FIG. 5, a roller clutch assembly 50 that is a second embodiment of the present invention is shown. The roller clutch assembly 50 includes an outer race 52 that is press fitted into the sprocket 3. The outer race 52 is formed with a plurality of axial recesses on its inner periphery similar to the recesses 10 described in the previous embodiment. The outer race 52 also includes an axial slot 54 having a variable configuration similar to the configuration of the outer tube slot 30 of FIG. 3, with portions 32, 34, 36, 38. Rollers 7 are placed between the outer race recesses and the shaft 1. The rollers 7 are held in location by a cage 56. The cage 56 is rotationally fixed to an inner tube 58 having an axial slot 57 with a configuration similar to inner tube slot 26. The rotational position of the cage 56, and thereby the rollers 7, relative to the outer race 52 is determined by the axial location of pin 28 which is controlled by the actual actuator 29. For 2WD operation, the pin 28 is retained in the slot portion 32 such that the cage 56 maintains its relative position to the outer race 52 and the rollers 7 are held centered in the outer race recesses. When locking is desired in a mode, the pin 28 is moved axially along the slots 52, 56, such that the outer race slot portions 34, 36, 38 provide freedom for relative rotation between the outer race 52 and cage 56 such that the rollers 7 climb the sides of the recesses and lock against the shaft 1 functionally similar to the FIG. 2 arrangement.

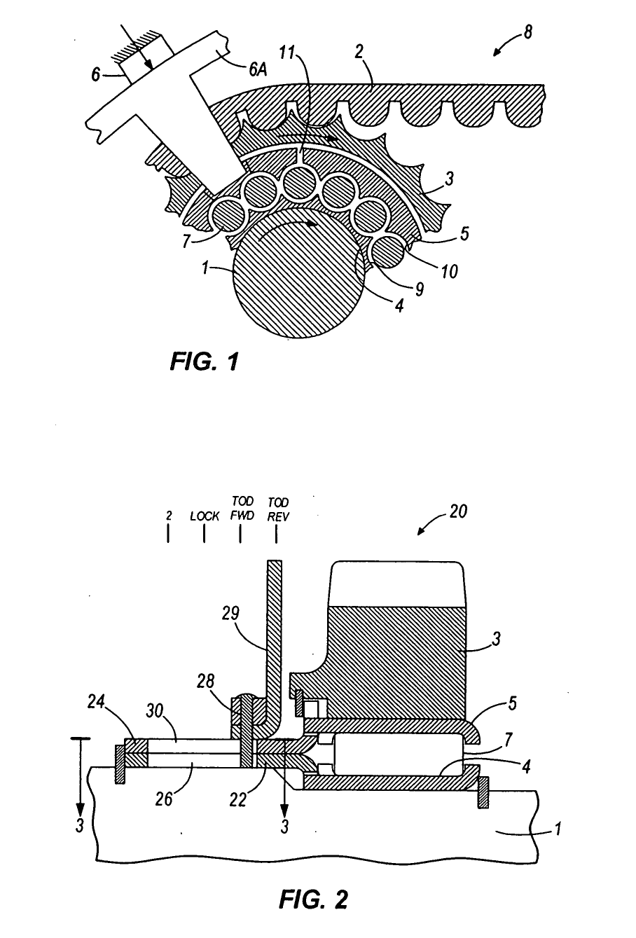

Referring to FIG. 6, a self contained slipper clutch assembly 60 that is a third embodiment of the present invention is shown. The slipper clutch assembly 60 includes an inner race 4 and a slipper 5. The inner race 4 includes splines 62 axially alignable and engageable with splines 64 on the slipper 5. While splines are described, other interlocking features may also be utilized. When the splines 62 and 64 are axially aligned, the splines 62 and 64 engage one another such that there is no relative rotation between the inner race 4 and slipper 5. As such, the recesses 9, 10 are maintained in alignment and the assembly 60 is prevented from locking. This provides 2WD mode. A stack of wave springs, 65, 66, holds the splines 62, 64 engaged. An axial actuator plate 67 is aligned with and contacts the slipper 5 and the wave springs 65, 66. A shift fork 68 or the lice is utilized to move the actuator plate 67 against the slipper S and wave springs 65, 66 to achieve the 4WD and TOD modes. Initial movement of the actuator plate 67 to the right causes the splines 62 and 64 to disengage as the weak wave spring 65 in the stack collapses. Once the splines 62 and 64 are disengaged, the inner race 4 and slipper 5 are free to rotate relative to one another in both directions. This provides an unconditional, full lock operation. Further movement of the shift fork 68, and thereby the actuator plate 67, causes a higher force to develop as the stiffer wave springs 66 collapse. The higher force causes a drag torque higher than the slipper friction to put the system into TOD mode similar to the function of the device described in FIG. 1. A cup 69 holds the sprocket 3 in a fixed axial location.

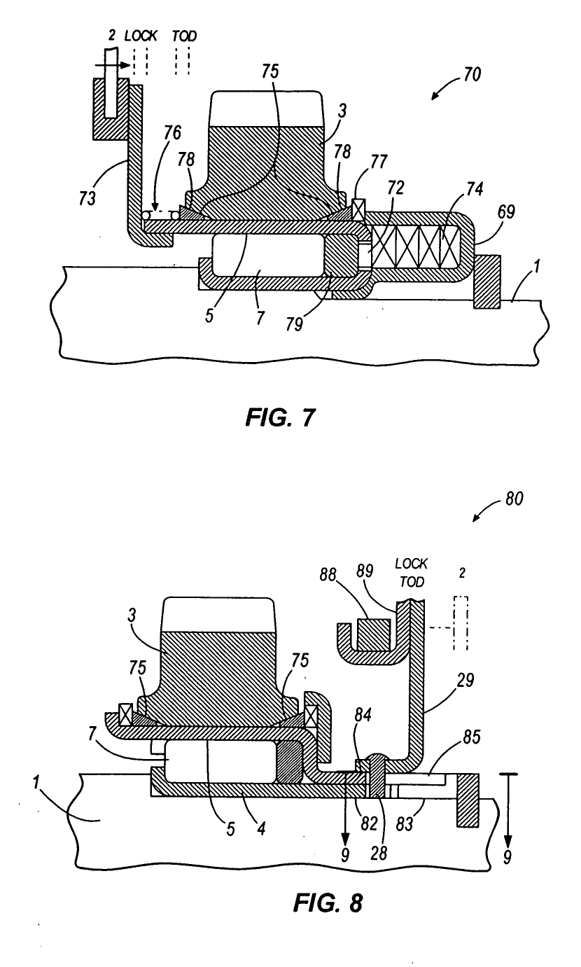

Referring to FIG. 7, a self contained slipper clutch assembly 70 that is a fourth embodiment of the present invention is shown. The clutch assembly 70 is similar to that shown in FIG. 6 and includes an inner race 4 and slipper 5, with an interengaging feature 72, for example, splines, therebetween. An axial actuator plate 73 is moved against the slipper 5 in a manner similar to the previous embodiment to achieve the various modes of operation. To reduce the frictional wear between the slipper 5 and the sprocket 3 when the slipper 5 rotates relative to the sprocket 3, a pair of conical plain bearings 75 is positioned between the slipper 5 and tapered surfaces 78 of the sprocket 3 and support the sprocket 3 away from the rotating slipper 5. The plain bearings 75 are loaded by springs 76 and 77, which allow the plain bearings 75 to back away as the slipper S expands to lock the clutch. The plain bearings 75 do not interfere with the locking action of the clutch. Ball bearings can be used instead of plain bearings. A spacer 79 may also be provided to position the rollers 7. FIG. 7 also illustrates an alternative construction of the device of FIG. 6 where the wave springs 74 are located in the cup 69.

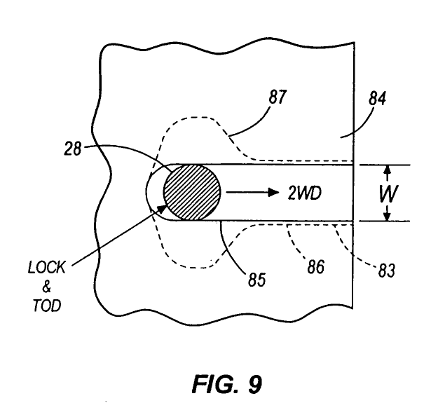

Referring to FIGS. 8 and 9, a self contained slipper clutch assembly 80 that is a fifth embodiment of the present invention is shown. The clutch assembly 80 is similar to that shown in FIG. 2 and includes an inner race 4 and slipper 5. Rather than providing independent tubes, the inner race 4 and slipper 5 are each provided with an axially extending flange 82 and 84, respectively. Each flange 82,84 includes a respective slot 83, 85 with a pin 28 extending therethrough. An actuator plate 29 is axially moveable to move the pin 28 within the slots. Referring to FIG. 9, slipper slot 85 has a constant width W similar to slot 26 while the inner race slot 83 includes a first portion 86 with a width substantially equal to the slipper slot width W and a second portion 87 with an expanded width in both circumferential directions.

The actuator plate 29 is moveable between two actuator positions. In the right position in which the pin 28 is in inner race slot portion 86, the inner race 4 and slipper 5 are closely aligned to prevent the clutch from locking to provide 2WD operation. When the pin 28 is moved to the left position aligned with the inner race slot portion 87 (as shown), there is freedom for the clutch to lock in either direction. This position allows for either full lock or TOD. To change between full lock and TOD, a drag band 88 is provided about a disc member 89 adjacent the second position of the actuator plate 29. When the drag band 88 is engaged, the actuator plate 29, through the pin 28 applies the drag band torque to the slipper 5 by way of the pin 28 and slot 85 to operate the clutch in TOD mode. The clutch assembly 80 may also include conical bearings 75 similar to those described in the previous embodiment. A roller clutch similar to that shown in FIG. 5 can also incorporate the feature of the present embodiment be providing the cage with a slot similar to 83 and the race has a slot similar to 85.

What is claimed is:

1. A four wheel drive system comprising
a bidirectional clutch;
an actuator plate;
a primary actuating system; and
a reverse actuating device,
wherein the bidirectional clutch has first and second tubular members each having a plurality of features which define pockets containing rollers, relative rotational orientation of said tubular members being controlled by axial movement of said actuator plate, said actuator plate being moved by a combination of the primary actuating system and the reverse actuating device.

2. The system according to claim 1 wherein one of the tubular members is a roller clutch race and the second tubular member is a roller cage.

3. The system according to claim 2 wherein the actuator plate carries a pin which engages two corresponding slots rotationally fixed to the race and the cage.

4. The system according to claim 1 wherein one of the tubular members is a slipper clutch slipper and the second is an opposing race.

5. The system according to claim 4 wherein the actuator plate carries a pin which engages two corresponding slots rotationally fixed to the slipper and the opposing race.

6. A “torque-on-demand” four wheel drive system comprising:
a drag brake, and
a slipper clutch, the slipper clutch comprising:
a slipper and
an opposing race, the slipper having features engageable with the opposing race, the engaging features being held in engagement by an axial spring
wherein the drag brake is axially actuating and actuation of the drag brake causes the engaging features to disengage.

7. A slipper clutch assembly comprising:
a slipper positioned within a bore of a rotatable component, the slipper having a first orientation wherein the slipper rotates within the bore and a second orientation wherein the slipper engages and rotates with the rotatable component, the rotatable component having tapered opposed edges; and
a pair of bearings positioned between the slipper and the rotatable component, each bearing being axially biased against a respective one of the tapered edges, such that when the slipper is in the first orientation, the bearings maintain the slipper spaced from the rotatable component and in the second orientation the bearings move axially and the slipper engages the rotatable component.

8. The clutch assembly according to claim 7 wherein the slipper clutch provides “torque-on-demand” operation for a four wheel drive system.

9. A “torque-on-demand” four wheel drive system comprising:
a slipper clutch positioned between a first rotatable component and a second rotatable component, the slipper clutch comprising:
a slipper having a first axial slot;
an opposing race having a second axial slot;
a control pin extending through and axially moveable within the first and second slots, wherein one of the first or second slots has a constant circumfemtial width W and the other of the first and second slots has at least first and second portions along its axial length with the first and second portions having different circumferential widths.

10. The system of claim 9 wherein the first portion has a circumferential width equal to the constant circumferential width W and the second portion has a circumferential width greater than the constant circumferential width W.

11. The system of claim 10 wherein the second portion is wider than the constant circumferential width W in both circumferential directions.

12. The system of claim 11 wherein the second slot further includes third and fourth portions along its axial length and wherein the third portion is wider than the constant circumferential width W in one circumferential direction and the fourth portion is wider than the constant circumferential width W in the opposite circumferential direction.

13. The system of claim 9 wherein the first axial slot has the constant circumfemtial width W and the second axial slot has the at least first and second portions along its axial length with the first and second portions having different circumferential widths.

14. The system of claim 9 wherein the second axial slot has the constant circumferntial width W and the first axial slot has the at least first and second portions along its axial length with the first and second portions having different circumferential widths.

15. A “torque-on-demand” four wheel drive system comprising:
a roller clutch positioned between a first rotatable component and a second rotatable component, the roller clutch comprising:
a race having a first axial slot;
a cage having a second axial slot and configured to receive a plurality rollers in rolling contact with the race;
a control pin extending through and axially moveable within the first and second slots, wherein one of the first or second slots has a constant circumfemtial width W and the other of the first and second slots has at least first and second portions along its axial length with the first and second portions having different circumferential widths.

16. The system of claim 15 wherein the first portion has a circumferential width equal to the constant circumferential width W and the second portion has a circumferential width greater than the constant circumferential width W.

17. The system of claim 16 wherein the second portion is wider than the constant circumferential width W in both circumferential directions.

18. The system of claim 17 wherein the second slot further includes third and fourth portions along its axial length and wherein the third portion is wider than the constant circumferential width W in one circumferential direction and the fourth portion is wider than the constant circumferential width W in the opposite circumferential direction.

19. The system of claim 15 wherein the first axial slot has the constant circumfemtial width W and the second axial slot has the at least first and second portions along its axial length with the first and second portions having different circumferential widths.

20. The system of claim 15 wherein the second axial slot has the constant circumferntial width W and the first axial slot has the at least first and second portions along its axial length with the first and second portions having different circumferential widths.
